(19) United States
(12) Patent Application Publication
(10) Pub. No.: US 2026/0230792 A1
(43) Pub. Date: Aug. 6, 2026

(54) NETWORK IDENTIFIER TRANSMISSION METHOD AND APPARATUS

(71) Applicant: BEIJING XIAOMI MOBILE SOFTWARE CO., LTD., Beijing (CN)

(72) Inventors: Haoran LIANG, Beijing (CN); Wei LU, Beijing (CN); Jianning LIU, Beijing (CN); Yang SHEN, Beijing (CN)

(21) Appl. No.: 19/154,333

(22) PCT Filed: Feb. 10, 2023
(86) PCT No.: PCT/CN2023/075540

§ 371 Date: Aug. 6, 2025

(51) Int. Cl. H04W 8/14; H04W 76/16; H04W 84/04

(52) U.S. Cl. CPC H04W 8/14; H04W 76/16; H04W 84/042

(57) ABSTRACT

A method for transmission of a network identifier, performed by a first entity, includes: determining networks currently accessed by a terminal; and sending network identifiers of two networks currently accessed by the terminal to a second entity.

### CROSS-REFERENCE TO RELATED APPLICATION

This application is a U.S. National Phase application of the International Patent Application No. PCT/CN2023/075540, filed Feb. 10, 2023, the entire contents of which are incorporated herein by reference.

### FIELD

The present disclosure relates to the field of communication technologies, and more particularly relates to a method and apparatus for transmission of a network identifier.

### BACKGROUND

An application function (AF) may obtain a public land mobile network (PLMN)/non-public network (NPN) identifier associated with an AF session from a policy control function (PCF) network element. Currently, the PCF can only provide one PLMN/NPN identifier to the AF.

### SUMMARY

In a first aspect, embodiments of the present disclosure provide a method for transmission of a network identifier, and the method includes: determining networks currently accessed by a terminal; and sending network identifiers of two networks currently accessed by the terminal to a second entity.

In a second aspect, embodiments of the present disclosure provide another method for transmission of a network identifier, and the method includes: receiving network identifiers of two networks sent by a first entity. The two networks are networks currently accessed by a terminal.

Embodiments of the present disclosure provide a communication apparatus, which includes a processor and a memory having stored therein computer programs. The processor is configured to execute the computer programs stored in the memory, to cause the communication apparatus to implement the method according to the first aspect described above.

Embodiments of the present disclosure provide a communication apparatus, which includes a processor and a memory having stored therein computer programs. The processor is configured to execute the computer programs stored in the memory, to cause the communication apparatus to implement the method according to the second aspect described above.

Embodiments of the present disclosure provide a communication apparatus, which includes a processor and an interface circuit. The interface circuit is configured to receive a code instruction and transmit the code instruction to the processor, and the processor is configured to run the code instruction to cause the apparatus to implement the method according to the first aspect described above.

Embodiments of the present disclosure provide a communication apparatus, which includes a processor and an interface circuit. The interface circuit is configured to receive a code instruction and transmit the code instruction to the processor, and the processor is configured to run the code instruction to cause the apparatus to implement the method according to the second aspect described above.

Embodiments of the present disclosure provide a non-transitory computer-readable storage medium for storing instructions used by the above first entity. The instructions, when executed, cause the first entity to implement the method according to the first aspect described above.

Embodiments of the present disclosure provide a non-transitory readable storage medium for storing instructions used by the above second entity. The instructions, when executed, cause the second entity to implement the method according to the second aspect described above.

### BRIEF DESCRIPTION OF THE DRAWINGS

Drawings to be used for the description of the embodiments of the present disclosure are briefly described below.

FIG. 1 is a schematic diagram of an architecture of a communication system according to embodiments of the present disclosure;

FIG. 2 is a schematic flowchart of a method for transmission of a network identifier according to embodiments of the present disclosure;

FIG. 3 is a schematic flowchart of another method for transmission of a network identifier according to embodiments of the present disclosure;

FIG. 4 is a schematic flowchart of another method for transmission of a network identifier according to embodiments of the present disclosure;

FIG. 5 is a schematic flowchart of another method for transmission of a network identifier according to embodiments of the present disclosure;

FIG. 6 is a schematic flowchart of another method for transmission of a network identifier according to embodiments of the present disclosure;

FIG. 7 is a schematic flowchart of another method for transmission of a network identifier according to embodiments of the present disclosure;

FIG. 8 is a schematic flowchart of another method for transmission of a network identifier according to embodiments of the present disclosure;

FIG. 9 is a schematic flowchart of another method for transmission of a network identifier according to embodiments of the present disclosure;

FIG. 10 is a schematic block diagram of a communication apparatus according to embodiments of the present disclosure;

FIG. 11 is a schematic block diagram of a communication apparatus according to embodiments of the present disclosure; and

FIG. 12 is a schematic block diagram of a chip according to embodiments of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. Instead, they are examples of apparatus and methods consistent with some aspects of the present disclosure as recited in the appended claims.

Terms used herein in embodiments of the present disclosure are for the purpose of describing specific embodiments, but should not be construed to limit embodiments of the present disclosure. As used in embodiments of the present disclosure and the appended claims, “a/an” and “the” in singular forms are intended to include plural forms, unless clearly indicated in the context otherwise. It should also be understood that, the term “and/or” used herein represents and contains any or all possible combinations of one or more associated listed items.

It should be understood that, although terms such as “first,” “second” and “third” may be used in embodiments of the present disclosure for describing various information, these information should not be limited by these terms. These terms are used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context. For the purpose of brevity and ease of understanding, terms “greater than” or “less than”, “higher than” or “lower than” are used herein to characterize size relationships. However, it may be understood by those skilled in the art that the term “greater than” also covers the meaning of “greater than or equal to”, and “less than” also covers the meaning of “less than or equal to”; the term “higher than” covers the meaning of “higher than or equal to”, and “lower than” also covers the meaning of “lower than or equal to”.

For ease of understanding, terms involved in the present disclosure are first introduced.

A PDU session refers to a process of communication between a terminal (such as a user equipment UE) and a data network (DN). When the PDU session is established, it means that a data transmission channel between the UE and the DN is established. A multi-access PDU session means that one UE may create a plurality of PDU sessions at the same time. For example, one UE initiates three PDU sessions at the same time, and the three PDU sessions are connected to different DNs respectively. For example, the DN may be a network supported by an operator, an Internet, or a local area network.

The terminal may carry out data transmission with a plurality of data networks via the MA PDU session. The MA PDU session may have a plurality of session channels. The session channels may be 3rd generation partnership project (3GPP) channels and non-3GPP channels, so that the service data of the session may be transmitted via a plurality of channel paths to ensure the reliability of data transmission.

Embodiments of the present disclosure provide a method and apparatus for transmission of a network identifier, which may be applied to the field of communications, and provides a transmission mechanism for network identifier information of an associated network in a case where a terminal is in a multi-access (MA) protocol data unit (PDU) scenario, so that a PCF network element may provide a network identifier of a network associated with an MA PDU session to an AF, so that the AF may obtain a PLMN identifier or an NPN identifier of a network assessed by the terminal in an MA PDU session scenario.

In a first aspect, embodiments of the present disclosure provide a method for transmission of a network identifier, and the method includes: determining networks currently accessed by a terminal; and sending network identifiers of two networks currently accessed by the terminal to a second entity.

In this technical solution, a first entity may be supported to send the network identifiers of the two networks to the second entity, and there is provided the transmission mechanism for the network identifier information of the associated networks in the case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

In a second aspect, embodiments of the present disclosure provide another method for transmission of a network identifier, and the method includes: receiving network identifiers of two networks sent by a first entity. The two networks are networks currently accessed by a terminal.

In a third aspect, embodiments of the present disclosure provide a communication apparatus, which has part or all of functions of the first entity for implementing the method according to the first aspect above. For example, the communication apparatus may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an implementation, a structure of the communication apparatus may include a transceiver module and a processing module, and the processing module is configured to support the communication apparatus to perform corresponding functions in the above method. The transceiver module is configured to support a communication between the communication apparatus and other devices. The communication apparatus may further include a storage module, which is configured to be coupled with the transceiver module and the processing module, and store necessary computer programs and data of the communication apparatus.

As an example, the processing module may be a processor, the transceiver module may be a transceiver or a communication interface, and the storage module may be a memory.

In a fourth aspect, embodiments of the present disclosure provide another communication apparatus, which has part or all of functions of the second entity for implementing the method examples according to the second aspect described above. For example, the communication apparatus may have functions as described in some or all of the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an implementation, a structure of the communication apparatus may include a transceiver module and a processing module, and the processing module is configured to support the communication apparatus to perform corresponding functions in the above method. The transceiver module is configured to support a communication between the communication apparatus and other devices. The communication apparatus may further include a storage module, which is configured to be coupled with the transceiver module and the processing module, and store computer programs and data of the communication apparatus.

In a fifth aspect, embodiments of the present disclosure provide a communication apparatus, which includes a processor. When the processor invokes a computer program in a memory, the method according to the first aspect described above is implemented.

In a sixth aspect, embodiments of the present disclosure provide a communication apparatus, which includes a processor. When the processor invokes a computer program in a memory, the method according to the second aspect described above is implemented.

In a seventh aspect, embodiments of the present disclosure provide a communication apparatus, which includes a processor and a memory having stored therein computer programs. The processor is configured to execute the computer programs stored in the memory, to cause the communication apparatus to implement the method according to the first aspect described above.

In an eighth aspect, embodiments of the present disclosure provide a communication apparatus, which includes a processor and a memory having stored therein computer programs. The processor is configured to execute the computer programs stored in the memory, to cause the communication apparatus to implement the method according to the second aspect described above.

In a ninth aspect, embodiments of the present disclosure provide a communication apparatus, which includes a processor and an interface circuit. The interface circuit is configured to receive a code instruction and transmit the code instruction to the processor, and the processor is configured to run the code instruction to cause the apparatus to implement the method according to the first aspect described above.

In a tenth aspect, embodiments of the present disclosure provide a communication apparatus, which includes a processor and an interface circuit. The interface circuit is configured to receive a code instruction and transmit the code instruction to the processor, and the processor is configured to run the code instruction to cause the apparatus to implement the method according to the second aspect described above.

In an eleventh aspect, embodiments of the present disclosure provide a system for transmission of a network identifier, which includes the communication apparatus according to the third aspect and the communication apparatus according to the fourth aspect, or includes the communication apparatus according to the fifth aspect and the communication apparatus according to the sixth aspect, or includes the communication apparatus according to the seventh aspect and the communication apparatus according to the eighth aspect, or includes the communication apparatus according to the ninth aspect and the communication apparatus according to the tenth aspect.

In a twelfth aspect, embodiments of the present disclosure provide a computer-readable storage medium for storing instructions used by the above first entity. The instructions, when executed, cause the first entity to implement the method according to the first aspect described above.

In a thirteenth aspect, embodiments of the present disclosure provide a readable storage medium for storing instructions used by the above second entity. The instructions, when executed, cause the second entity to implement the method according to the second aspect described above.

In a fourteenth aspect, the present disclosure further provides a computer program product, which includes a computer program that, when run on a computer, causes the computer to implement the method according to the first aspect described above.

In a fifteenth aspect, the present disclosure further provides a computer program product, which includes a computer program that, when run on a computer, causes the computer to implement the method according to the second aspect described above.

In a sixteenth aspect, the present disclosure provides a chip system, which includes at least one processor and an interface, for supporting a first entity to implement functions involved in the first aspect, for example, determining or processing at least one of data and information involved in the above method. In a possible design, the chip system further includes a memory for storing computer programs and data necessary for the first entity. The chip system may consist of chips, or may include chips and other discrete devices.

In a seventeenth aspect, the present disclosure provides a chip system, which includes at least one processor and an interface, for supporting a second entity to implement functions involved in the second aspect, for example, determining or processing at least one of data and information involved in the above method. In a possible design, the chip system further includes a memory for storing computer programs and data necessary for the second entity. The chip system may consist of chips, or may include chips and other discrete devices.

In an eighteenth aspect, the present disclosure provides a computer program that, when run on a computer, causes the computer to implement the method according to the first aspect described above.

In a nineteenth aspect, the present disclosure provides a computer program that, when run on a computer, causes the computer to implement the method according to the second aspect described above.

In order to better understand a method for transmission of a network identifier described in embodiments of the present disclosure, a communication system to which embodiments of the present disclosure are applicable is firstly described below.

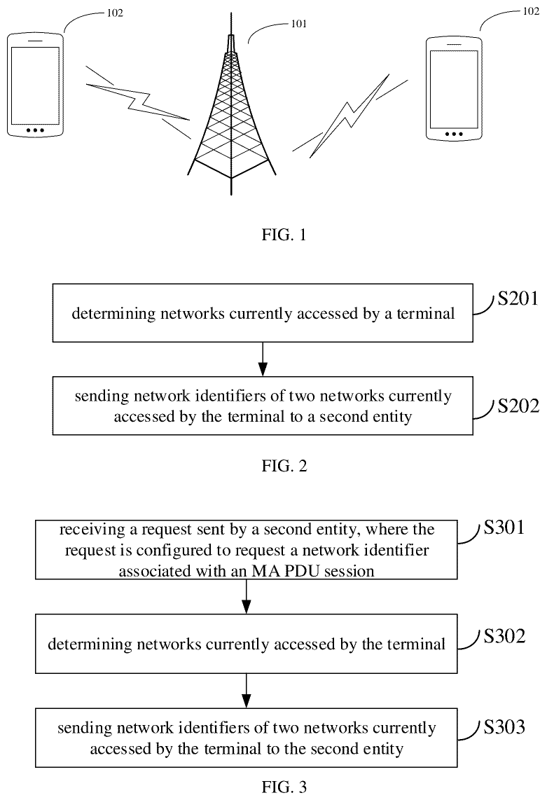

Referring to FIG. 1, FIG. 1 is a schematic diagram of an architecture of a communication system according to embodiments of the present disclosure. The communication system may include, but is not limited to, one network device and one terminal. The number and forms of the devices shown in FIG. 1 are used as an example and do not constitute a limitation on embodiments of the present disclosure. The communication system may include two or more network devices and two or more terminals in practical applications. As an example, the communication system shown in FIG. 1 includes one network device 101 and one terminal 102.

It should be noted that the technical solutions of embodiments of the present disclosure may be applied to various communication systems, for example, a 3th generation (3G) universal mobile telecommunications system (UMTS), long term evolution (LTE) system, a 5th generation (5G) mobile communication system, a 5G new radio (NR) system, a 6th generation (6G) mobile communication system, or other future new mobile communication systems.

The network device 101 in embodiments of the present disclosure is an entity at a network side for sending or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (Wi-Fi) system. The specific technology and specific device form adopted by the network device are not limited in embodiments of the present disclosure. The network device according to embodiments of the present disclosure may be composed of a central unit (CU) and distributed units (DU). The CU may also be called a control unit. Using the CU-DU structure allows to split protocol layers of the network device, such as the base station, so that functions of some of the protocol layers are centrally controlled in the CU, functions of some or all of the remaining protocol layers are distributed in the DUs, and the CU centrally controls the DUs.

The terminal 102 in embodiments of the present disclosure is an entity at a user side for receiving or sending signals, such as a mobile phone. The terminal may also be called a terminal, a user equipment (UE), a mobile station (MS), a mobile terminal (MT), and so on. The terminal may be a device with a communication function, such as a car, a smart car, a mobile phone, a wearable device, a tablet computer (Pad), a computer with a wireless transceiver function, a virtual reality (VR) terminal, an augmented reality (AR) terminal, a wireless terminal in an industrial control, a wireless terminal in a self-driving, a wireless terminal in a remote medical surgery, a wireless terminal in a smart grid, a wireless terminal in a transportation safety, a wireless terminal in a smart city, a wireless terminal in a smart home, etc. The specific technology and the specific device form adopted by the terminal are not limited in embodiments of the present disclosure.

It may be understood that the communication system described in embodiments of the present disclosure is intended to illustrate the technical solutions of embodiments of the present disclosure more clearly, and does not constitute a limitation on the technical solutions according to embodiments of the present disclosure. Those of ordinary skill in the art will know that with an evolution of system architecture and an emergence of a new service scenario, the technical solutions according to embodiments of the present disclosure are also applicable to similar technical problems.

It should be noted that in the present disclosure, a method for transmission of a network identifier provided in any embodiment may be executed alone, or may be executed together in combination with possible implementations in other embodiments, or may be executed together in combination with any technical solution in the related art.

A method and apparatus for transmission of a network identifier provided by the present disclosure will be described in detail below with reference to the accompanying drawings.

Referring to FIG. 2, FIG. 2 is a schematic flowchart of a method for transmission of a network identifier according to embodiments of the present disclosure. The method for the transmission of the network identifier may be performed by a first entity. As shown in FIG. 2, the method may include, but is not limited to, the following steps.

In S201, networks currently accessed by a terminal are determined.

In embodiments of the present disclosure, the terminal may support MA PDU session, that is, the terminal may access a plurality of networks at the same time, and establish PDU sessions with the plurality of networks respectively at the same time. Optionally, the plurality of networks accessed by the terminal at the same time may include public networks supported by different operators. Optionally, the plurality of networks accessed by the terminal at the same time may include public networks supported by operators, and may also include non-public networks (NPNs). Optionally, the plurality of networks accessed by the terminal at the same time may include different NPNs.

In some implementations, the terminal may access a home network and one visited network at the same time.

In some implementations, the terminal may access a home network and two visited networks at the same time.

In some implementations, the terminal may access two non-public networks at the same time.

In a possible implementation, the first entity may obtain PDU session information corresponding to the terminal, and determine the networks currently accessed by the terminal according to the PDU session information corresponding to the terminal. It may be understood that, in embodiments of the present disclosure, the terminal is in an MA PDU session scenario, and the networks currently accessed by the terminal are networks associated with the MA PDU session.

In some implementations, the first entity in embodiments of the present disclosure may include, but is not limited to, a policy control function (PCF) network element in a core network.

In S202, network identifiers of two networks currently accessed by the terminal are sent to a second entity.

In some implementations, the terminal may access a plurality of networks supported by different operators at the same time. In a case where the terminal accesses the plurality of networks at the same time, in embodiments of the present disclosure, after the first entity determines the networks currently accessed by the terminal, network identifiers of the currently accessed networks may be obtained, and the first entity may send network identifiers of two networks in the currently accessed networks to the second entity.

Optionally, in a scenario where the terminal accesses a home network and one visited network at the same time, the first entity may determine network identifiers of the visited network currently visited by the terminal and the home network as the network identifiers of the two networks to be sent, and send them to the second entity. That is, the first entity sends the network identifier of the visited network and the network identifier of the home network to the second entity at the same time.

Optionally, in a scenario where the terminal accesses one home network and two visited networks at the same time, the first entity may determine network identifiers of the two visited networks currently visited by the terminal as the network identifiers of the two networks to be sent, and send them to the second entity.

Optionally, in a scenario where the terminal accesses a plurality of NPN networks at the same time, the first entity may determine network identifiers of two NPNs currently accessed by the terminal as the network identifiers of the two networks to be sent, and send them to the second entity.

Optionally, a combination of any two network identifiers among different networks is specified or configured in advance, and different combinations correspond to different index values. The first entity may send the index value as first indication information to the second entity. The second entity may receive the first indication information, and the first indication information is an index value of a combination. Further, the second entity determines the network identifiers of the two networks according to the index value. The first entity may implicitly indicate the network identifiers of the two networks currently accessed by the terminal to the second entity through the index value.

Optionally, the first entity may send second indication information carrying the network identifiers of the two networks, and the second entity may receive the second indication information and directly obtain the network identifiers of the two networks from the second indication information. The first entity may explicitly indicate the network identifiers of the two networks currently accessed by the terminal to the second entity.

In some implementations, the network identifiers of the two networks sent by the first entity to the second entity may be public land mobile network (PLMN) identifiers or NPN network identifiers, where the NPN network identifier includes a PLMN identifier and a network identity (NID). For example, in a case where the networks currently accessed by the terminal are public land mobile networks, the network identifiers of the two networks sent by the first entity to the second entity are both the PLMN identifiers. For another example, in a case where the networks currently accessed by the terminal are non-public networks, the network identifiers of the two networks sent by the first entity to the second entity are both the NID identifiers.

In some implementations, the second entity in embodiments of the present disclosure may include, but is not limited to, an AF network element in a core network or an application function of a third party.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

Referring to FIG. 3, FIG. 3 is a schematic flowchart of a method for transmission of a network identifier according to embodiments of the present disclosure. The method for the transmission of the network identifier may be performed by a first entity. As shown in FIG. 3, the method may include, but is not limited to, the following steps.

In S301, a request sent by a second entity is received, and the request is configured to request a network identifier associated with an MA PDU session.

In some implementations, the first entity in embodiments of the present disclosure may include, but is not limited to, a PCF network element in a core network. In some implementations, the second entity in embodiments of the present disclosure may include, but is not limited to, an AF network element in the core network and an application function of a third party.

In some implementations, the second entity may send the request to the first entity, and the request includes the MA PDU session information and/or AF session information corresponding to the MA PDU session. The first entity may receive the above request sent by the second entity, and determine the MA PDU session information and/or the AF session information from the request. In some implementations, the request sent by the second entity may also include a device identifier of a terminal. Optionally, the request sent by the second entity may be a subscription request sent to the first entity.

In S302, networks currently accessed by the terminal are determined.

In some implementations, the terminal may access a home network and one visited network at the same time.

In some implementations, the terminal may access a home network and two visited networks at the same time.

In some implementations, the terminal may access two non-public networks at the same time.

In some implementations, the request sent by the second entity includes the AF session information, and after determining the AF session information based on the request, the first entity may determine MA PDU session information according to the AF session information. Optionally, the MA PDU session information may indicate one or more networks that establish the PDU session with the terminal. In embodiments of the present disclosure, after determining the MA PDU session information, the first entity may obtain the network identifiers of the networks currently accessed by the terminal based on the MA PDU session information.

In some implementations, the request sent by the second entity includes the MA PDU session information, and the first entity may query and obtain the network identifiers of the networks currently accessed by the terminal according to the MA PDU session information in the request.

In S303, network identifiers of two networks currently accessed are sent to the second entity.

In embodiments of the present disclosure, the S303 may be implemented by any manner as described in embodiments of the present disclosure, which is not limited here and will not be repeated.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

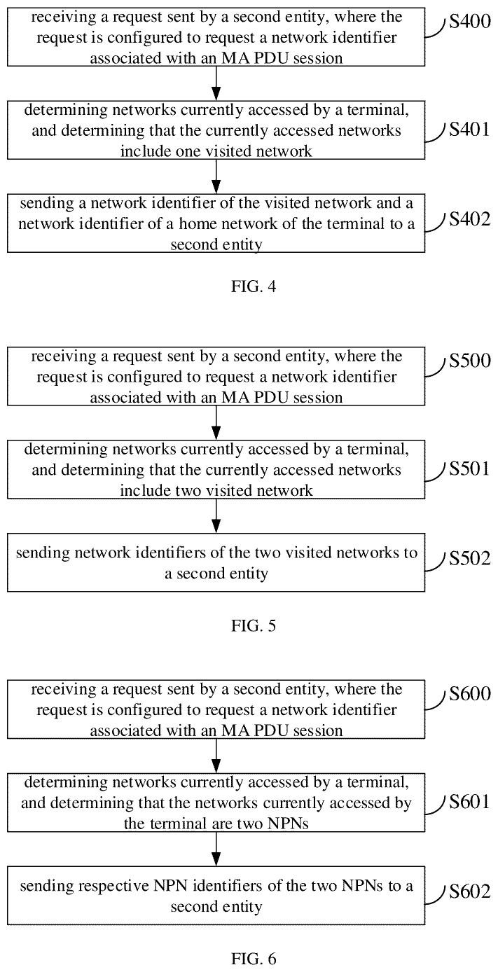

Referring to FIG. 4, FIG. 4 is a schematic flowchart of a method for transmission of a network identifier according to embodiments of the present disclosure. The method for the transmission of the network identifier may be performed by a first entity. As shown in FIG. 4, the method may include, but is not limited to, the following steps.

In S401, networks currently accessed by a terminal are determined, and it is determined that the networks currently accessed include one visited network.

In S402, a network identifier of the visited network and a network identifier of a home network of the terminal are sent to a second entity.

In some implementations, the first entity in embodiments of the present disclosure may include, but is not limited to, a PCF network element in a core network. In some implementations, the second entity in embodiments of the present disclosure may include, but is not limited to, an AF network element in a core network and an application function of a third party.

In some implementations, the terminal may access a home network and one visited network at the same time. In a scenario where the terminal accesses the home network and the one visited network at the same time, the first entity may regard the network identifier of the visited network currently visited by the terminal and the network identifier of the home network as network identifiers of two networks to be sent, and send them to the second entity. That is, the first entity sends the network identifier of the visited network and the network identifier of the home network to the second entity at the same time.

In embodiments of the present disclosure, the home network and the visited network of the terminal are public land mobile networks. It may be understood that the network identifiers of the two networks sent by the first entity to the second entity are both PLMN identifiers.

In some implementations, the first entity may implicitly indicate the PLMN identifies of the two networks to the second entity. In some implementations, the first entity may explicitly indicate the PLMN identifies of the two networks to the second entity. For the specific process of the implicit or explicit indication manner of the first entity, reference may be made to the relevant contents recorded in the S202 in the above embodiments, which will not be repeated here.

The method for the transmission of the network identifier according to embodiments of the present disclosure may further include a following step.

In S400, a request sent by the second entity is received, and the request is configured to request a network identifier associated with an MA PDU session.

In embodiments of the present disclosure, the S400 may be implemented by any manner as described in embodiments of the present disclosure, which is not limited here and will not be repeated.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier of the public network accessed by the terminal in the MA PDU session scenario.

Referring to FIG. 5, FIG. 5 is a schematic flowchart of a method for transmission of a network identifier according to embodiments of the present disclosure. The method for the transmission of the network identifier may be performed by a first entity. As shown in FIG. 5, the method may include, but is not limited to, the following steps.

In S501, networks currently accessed by a terminal are determined, and it is determined that the networks currently accessed include two visited network.

In S502, network identifiers of the two visited networks are sent to a second entity.

In some implementations, the terminal may access a home network and two visited networks at the same time. In a scenario where the terminal accesses one home network and the two visited network at the same time, the first entity may send the network identifiers of the two visited networks currently visited by the terminal to the second entity.

In embodiments of the present disclosure, the home network and the visited network of the terminal are public land mobile networks. It may be understood that the network identifiers of the two visited networks sent by the first entity to the second entity are both PLMN identifiers.

In some implementations, the first entity may implicitly indicate the PLMN identifies of the two networks to the second entity. In some implementations, the first entity may explicitly indicate the PLMN identifies of the two networks to the second entity. For the specific process of the implicit or explicit indication manner of the first entity, reference may be made to the relevant contents recorded in the S202 in the above embodiments, which will not be repeated here.

The method for the transmission of the network identifier according to embodiments of the present disclosure may further include a following step.

In S500, a request sent by the second entity is received, and the request is configured to request a network identifier associated with an MA PDU session.

In embodiments of the present disclosure, the S500 may be implemented by any manner as described in embodiments of the present disclosure, which is not limited here and will not be repeated.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier of the public network accessed by the terminal in the MA PDU session scenario.

Referring to FIG. 6, FIG. 6 is a schematic flowchart of a method for transmission of a network identifier according to embodiments of the present disclosure. The method for the transmission of the network identifier may be performed by a first entity. As shown in FIG. 6, the method may include, but is not limited to, the following steps.

In S601, networks currently accessed by a terminal are determined, and it is determined that the networks currently accessed by the terminal are two NPNs.

In S602, respective NPN identifiers of the two NPNs are sent to a second entity.

In some implementations, the terminal may access a plurality of NPN networks at the same time. In a scenario where the terminal accesses a plurality of NPN networks at the same time, the first entity may send network identifiers of two NPNs currently accessed by the terminal to the second entity. It should be noted that the network identifier of the NPN may include a PLMN identifier and an NID.

In some implementations, the first entity may implicitly indicate the NPN identifies of the two networks to the second entity. In some implementations, the first entity may explicitly indicate the NPN identifies of the two networks to the second entity. For the specific process of the implicit or explicit indication manner of the first entity, reference may be made to the relevant contents recorded in the S202 as described in the above embodiments, which will not be repeated here.

The method for the transmission of the network identifier according to embodiments of the present disclosure may further include a following step.

In S600, a request sent by the second entity is received, and the request is configured to request a network identifier associated with an MA PDU session.

In embodiments of the present disclosure, the S600 may be implemented by any manner as described in embodiments of the present disclosure, which is not limited here and will not be repeated.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the NPN identifier of the non-public network accessed by the terminal in the MA PDU session scenario.

Referring to FIG. 7, FIG. 7 is a schematic flowchart of a method for transmission of a network identifier according to embodiments of the present disclosure. The method for the transmission of the network identifier may be performed by a second entity. As shown in FIG. 7, the method may include, but is not limited to, a following step.

In S701, network identifiers of two networks sent by a first entity are received, and the two networks are networks currently accessed by a terminal.

In embodiments of the present disclosure, the terminal may support MA PDU session, that is, the terminal may access a plurality of networks at the same time, and establish PDU sessions with the plurality of networks respectively at the same time. Optionally, the plurality of networks accessed by the terminal at the same time may include public networks supported by different operators. Optionally, the plurality of networks accessed by the terminal at the same time may include public networks supported by operators, and may also include NPNs. Optionally, the plurality of networks accessed by the terminal at the same time may include different NPNs.

In some implementations, the terminal may access a home network and one visited network at the same time.

In some implementations, the terminal may access a home network and two visited networks at the same time.

In some implementations, the terminal may access two non-public networks at the same time.

In a possible implementation, the first entity may obtain PDU session information corresponding to the terminal, and determine the networks currently accessed by the terminal according to the PDU session information corresponding to the terminal.

After determining networks currently accessed by the terminal, the first entity may obtain network identifiers of the networks currently accessed, and the first entity may send the network identifiers of the two networks currently accessed to the second entity. Accordingly, the second entity may receive the network identifiers of the two networks sent by the first entity.

Optionally, in a scenario where the terminal accesses a home network and one visited network at the same time, the second entity may receive the network identifier of the visited network currently visited by the terminal and the network identifier of the home network of the terminal sent by the first entity. That is, the networks currently accessed by the terminal include the one visited network, and the second entity may receive the network identifier of the visited network and the network identifier of the home network of the terminal sent by the first entity.

Optionally, in a scenario where the terminal accesses one home network and two visited networks at the same time, the second entity may receive network identifiers of the two visited networks currently visited by the terminal from the first entity. That is, the networks currently accessed by the terminal include the two visited networks, and the second entity may receive the network identifiers of the two visited networks from the first entity.

In embodiments of the present disclosure, the home network and the visited network of the terminal are public land mobile networks. It may be understood that the network identifiers of the two networks sent by the first entity to the second entity are both PLMN identifiers.

Optionally, in a scenario where the terminal accesses a plurality of NPN networks at the same time, the second entity may receive network identifiers of two NPNs currently accessed by the terminal from the first entity. That is, in a case where the networks currently accessed by the terminal are NPN networks, the second entity may receive the network identifiers of the two NPNs sent by the first entity.

Optionally, a combination of any two network identifiers among different networks is specified or configured in advance, and different combinations correspond to different index values. The first entity may send the index value as first indication information to the second entity. Accordingly, the second entity may receive the first indication information, and the first indication information is an index value of a combination. The second entity determines the network identifiers of the two networks according to the index value. The first entity may implicitly indicate the network identifiers of the two networks currently accessed by the terminal to the second entity through the index value.

Optionally, the first entity may send second indication information carrying the network identifiers of the two networks, and accordingly, the second entity may receive the second indication information and directly obtain the network identifiers of the two networks from the second indication information. The first entity may explicitly indicate the network identifiers of the two networks currently accessed by the terminal to the second entity.

In some implementations, the network identifiers of the two networks sent by the first entity to the second entity may be PLMN identifiers or NPN network identifiers, where the NPN network identifier includes a PLMN identifier and an NID. For example, in a case where the networks currently accessed by the terminal are public land mobile networks, the network identifiers of the two networks sent by the first entity to the second entity are both the PLMN identifiers. For another example, in a case where the networks currently accessed by the terminal are non-public networks, the network identifiers of the two networks sent by the first entity to the second entity are both the NID identifiers.

In some implementations, the first entity in embodiments of the present disclosure may include, but is not limited to, a PCF network element in a core network. In some implementations, the second entity in embodiments of the present disclosure may include, but is not limited to, an AF network element in the core network or an application function of a third party.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

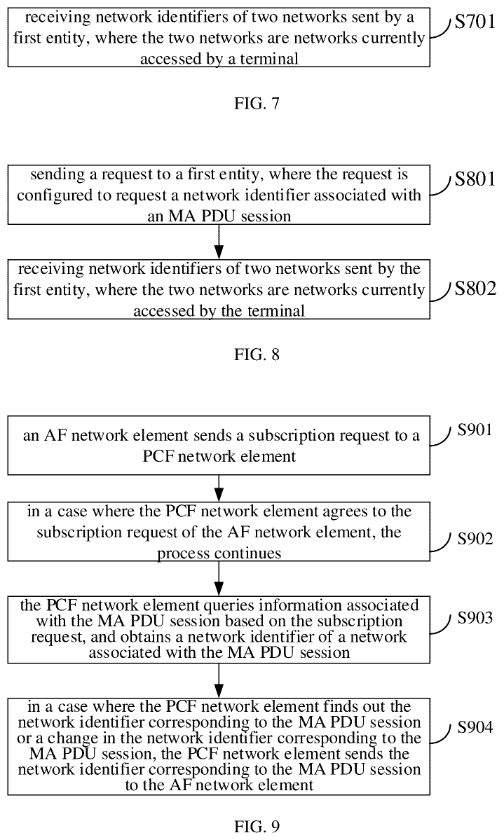

Referring to FIG. 8, FIG. 8 is a schematic flowchart of a method for transmission of a network identifier according to embodiments of the present disclosure. The method for the transmission of the network identifier may be performed by a second entity. As shown in FIG. 8, the method may include, but is not limited to, the following steps.

In S801, a request is sent to a first entity, and the request is configured to request a network identifier associated with an MA PDU session.

In some implementations, the first entity in embodiments of the present disclosure may include, but is not limited to, a PCF network element in a core network. In some implementations, the second entity in embodiments of the present disclosure may include, but is not limited to, an AF network element in a core network and an application function of a third party.

In some implementations, the second entity may send the request to the first entity, and the request includes AF session information corresponding to the MA PDU session. The first entity may receive the above request sent by the second entity, and determine the AF session information from the request.

In some implementations, after determining the AF session information based on the request, the first entity may determine MA PDU session information according to the AF session information. Optionally, the MA PDU session information may indicate one or more networks that establish the PDU session with the terminal. In embodiments of the present disclosure, after determining the MA PDU session information, the first entity may obtain the network identifiers of the networks currently accessed by the terminal based on the MA PDU session information.

The second entity may determine the MA PDU session information according to the AF session information in the request, and further query and obtain the network identifiers of the networks currently accessed by the terminal according to the MA PDU session information.

In S802, network identifiers of two networks sent by the first entity are received, and the two networks are networks currently accessed by the terminal.

In embodiments of the present disclosure, the S802 may be implemented by any manner as described in embodiments of the present disclosure, which is not limited here and will not be repeated.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF may provide the network identifiers of the networks associated with the MA PDU session to the AF network element, so that the AF may obtain the PLMN identifier or NPN identifier of the network assessed by the terminal in the MA PDU session scenario.

Referring to FIG. 9, FIG. 9 is a schematic flowchart of a method for transmission of a network identifier according to embodiments of the present disclosure. As shown in FIG. 9, the method may include, but is not limited to, the following steps.

In S901, an AF network element sends a subscription request to a PCF network element.

In embodiments of the present disclosure, the subscription request is configured to subscribe to a network identifier of a network associated with an MA PDU session.

Optionally, the subscription request may include AF session information. In some implementations, the request sent by the AF network element may also include a device identifier of a terminal.

It should be noted that, in order for the PCF network element to send a PLMN identifier and/or an NPN identifier to the AF network element, the AF network element may subscribe/unsubscribe to notifications of events from the PCF network element for the PDU session to which the AF session is bound. The AF network element may subscribe/unsubscribe directly at the PCF network element, or may subscribe/unsubscribe indirectly via a network exposure function (NEF) network element or a time sensitive communication and time synchronization function (TSCTSF) network element.

In some implementations, the AF network element may request the PCF network element to report a PLMN identifier where the UE is currently located or an available NPN identifier via the subscription request, and the PCF network element shall provide the PLMN identifier or the available NPN identifier to the AF network element.

In S902, in a case where the PCF network element agrees to the subscription request of the AF network element, the process continues.

In embodiments of the present disclosure, in a case where the PCF network element does not agree to the subscription request of the AF network element, the process ends.

In S903, the PCF network element queries information associated with the MA PDU session based on the subscription request, and obtains a network identifier of a network associated with the MA PDU session.

It may be understood that the network associated with the MA PDU session corresponds to the network currently accessed by the terminal as described in the above embodiments of the present disclosure.

In S904, in a case where the PCF network element finds out the network identifier corresponding to the MA PDU session or a change in the network identifier corresponding to the MA PDU session, the PCF network element sends the network identifier corresponding to the MA PDU session to the AF network element.

In some implementations, the PCF network element may query the network identifier corresponding to the network associated with the MA PDU session based on MA PDU session information, and feed back the network identifier of the network associated with the MA PDU session to the AF network element. For example, the network identifier may be a PLMN identifier or an NPN identifier.

In some implementations, the PCF network element may also feed back the network identifier of the network associated with the MA PDU session to the AF network element when it finds out a change in the network identifier corresponding to the MA PDU session.

In some implementations, the AF may perform parameter configuration for the associated network according to the network identifier of the network associated with the MA PDU session.

It should be noted that in a case where the PCF network element cannot provide the PLMN identifier or the available NPN identifier to the AF network element, the PCF network element triggers a policy control request trigger to send PLMN update information to the SMF network element according to a preset policy control and charging (PCC) rule. The PCF network element receives the PLMN update information from a session management function (SMF) network element, may determine the PLMN identifier or the NPN identifier, and send the PLMN identifier or the NPN identifier to the AF network element. The NPN identifier includes the PLMN identifier and the available NID.

In the above embodiments provided in the present disclosure, the methods provided in the embodiments of the present disclosure are introduced from the perspectives of the first entity and the second entity, respectively. In order to implement the various functions as descried in the above-mentioned methods provided in the embodiments of the present disclosure, the first entity and the second entity may include a hardware structure and a software module to implement the above-mentioned various functions in the form of the hardware structure, the software module, or the hardware structure plus the software module. A certain one of the above functions may be implemented in the form of the hardware structure, the software module, or the hardware structure plus the software module.

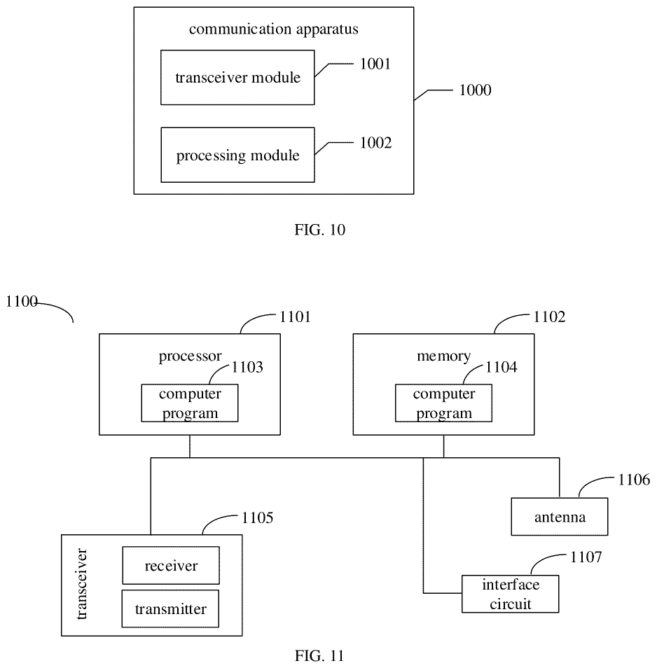

Referring to FIG. 10, FIG. 10 is a schematic block diagram of a communication apparatus 1000 according to embodiments of the present disclosure. The communication apparatus 1000 shown in FIG. 10 may include a transceiver module 1001 and a processing module 1002. The transceiver module 1001 may include a sending module and/or a receiving module. The sending module is configured to implement a sending function, and the receiving module is configured to implement a receiving function. The transceiver module 1001 may implement a sending function and/or a receiving function.

The communication apparatus 1000 may be a first entity, a device in a first entity, or a device that may be used in cooperation with a first entity. Alternatively, the communication apparatus 1000 may be a second entity, a device in a second entity, or a device that may be used in cooperation with a second entity.

The communication apparatus 1000 is a first entity:

The processing module 1002 is configured to determine networks currently accessed by a terminal.

The transceiver module 1001 is configured to send network identifiers of two networks currently accessed by the terminal to a second entity.

In some implementations, the processing module 1002 is further configured to determine that the networks currently accessed by the terminal include one visited network. The transceiver module 1001 is further configured to send a network identifier of the visited network and a network identifier of a home network of the terminal to the second entity.

In some implementations, the processing module 1002 is further configured to determine that the networks currently accessed by the terminal include two visited networks. The transceiver module 1001 is further configured to send respective network identifiers of the two visited networks to the second entity.

In some implementations, the network identifier includes a PLMN identifier of a public land mobile network.

In some implementations, the processing module 1002 is further configured to determine that the networks currently accessed by the terminal are two non-public networks (NPNs). The transceiver module 1001 is further configured to send respective NPN identifiers of the two NPNs to the second entity.

In some implementations, the NPN identifier includes a PLMN identifier and a network identifier (NID).

In some implementations, the transceiver module 1001 is further configured to receive a request sent by the second entity, and the request is configured to request a network identifier associated with an MA PDU session.

The communication apparatus 1000 is a second entity:

The transceiver module 1001 is configured to receive network identifiers of two networks sent by a first entity, and the two networks are networks currently accessed by a terminal.

In some implementations, the transceiver module 1001 is further configured to, in a case where the networks currently accessed by the terminal include one visited network, receive a network identifier of the visited network and a network identifier of a home network of the terminal sent by the first entity.

In some implementations, the transceiver module 1001 is further configured to, in a case where the networks currently accessed by the terminal include two visited networks, receive respective network identifiers of the two visited networks sent by the first entity.

In some implementations, the network identifier includes a PLMN identifier of a public land mobile network.

In some implementations, the transceiver module 1001 is further configured to, in a case where the networks currently accessed by the terminal are two non-public networks (NPNs), receive respective NPN identifiers of the two NPNs sent by the first entity.

In some implementations, the NPN identifier includes a PLMN identifier and an NID.

In some implementations, the transceiver module 1001 is further configured to send a request to the first entity, and the request is configured to request a network identifier associated with an MA PDU session.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

Referring to FIG. 11, FIG. 11 is a schematic block diagram of another communication apparatus 1100 according to embodiments of the present disclosure, the communication apparatus 1100 may be an entity, may also be a terminal (such as the first terminal in the aforementioned method embodiments), may also be a chip, a chip system, or a processor that supports the entity to implement the above methods, and may also be a chip, a chip system, or a processor that supports the terminal to implement the above methods. The apparatus may be configured to implement the methods as described in the above method embodiments, and for details, reference may be made to the descriptions in the above method embodiments.

The communication apparatus 1100 may include one or more processors 1101. The processor 1101 may be a general-purpose processor or a special-purpose processor. For example, it may be a baseband processor or a central processing unit. The baseband processor may be configured to process a communication protocol and communication data, and the central processing unit may be configured to control a communication apparatus (such as a base station, a baseband chip, a terminal, a terminal chip, a DU or a CU, etc.), execute computer programs, and process data of computer programs.

Optionally, the communication apparatus 1100 may further include one or more memories 1102 having stored therein a computer program 1104. The processor 1101 executes the computer program 1104, to cause the communication apparatus 1100 to implement the methods as described in the above method embodiments. Optionally, the memory 1102 may have stored therein data. The communication apparatus 1100 and the memory 1102 may be provided separately or integrated together.

Optionally, the communication apparatus 1100 may further include a transceiver 1105 and an antenna 1106. The transceiver 1105 may be called a transceiver element, a transceiver machine, a transceiver circuit or the like, for implementing a transceiver function. The transceiver 1105 may include a receiver and a transmitter. The receiver may be called a receiving machine, a receiving circuit or the like, for implementing a receiving function. The transmitter may be called a sending machine, a sending circuit or the like, for implementing a sending function.

Optionally, the communication apparatus 1100 may further include one or more interface circuits 1107. The interface circuit 1107 is configured to receive a code instruction and transmit the code instruction to the processor 1101. The processor 1101 runs the code instruction to enable the communication apparatus 1100 to execute the methods as described in the foregoing method embodiments.

The communication apparatus 1100 is a first entity: the processor 1101 is configured to execute the S201 in FIG. 2; execute the S302 in FIG. 3; the S401 in FIG. 4; the S501 in FIG. 5; or the S601 in FIG. 6. The transceiver 1105 is configured to execute the S202 in FIG. 2; execute the S301 and the S303 in FIG. 3; execute the S400 and the S402 in FIG. 4; execute the S500 and the S502 in FIG. 5; or execute the S600 and the S602 in FIG. 6.

The communication apparatus 1100 is a second entity: the transceiver 1105 is configured to execute the S701 in FIG. 7; or execute the S801 and the S802 in FIG. 8.

In an implementation manner, the processor 1101 may include the transceiver configured to implement receiving and sending functions. For example, the transceiver may be a transceiver circuit, an interface, or an interface circuit. The transceiver circuit, the interface or the interface circuit configured to implement the receiving and sending functions may be separated or may be integrated together. The above transceiver circuit, interface or interface circuit may be configured to read or write codes/data, or the above transceiver circuit, interface or interface circuit may be configured to transmit or transfer signals.

In an implementation manner, the processor 1101 may have stored therein a computer program 1103 that, when run on the processor 1101, causes the communication apparatus 1100 to implement the methods as described in the foregoing method embodiments. The computer program 1103 may be embedded in the processor 1101, and in this case, the processor 1101 may be implemented by hardware.

In an implementation manner, the communication apparatus 1100 may include a circuit, and the circuit may implement the sending, receiving or communicating function in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), a negative metal-oxide-semiconductor (also called nMetal-oxide-semiconductor, NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus described in the above embodiments may be the first entity or the second entity, but the scope of the communication apparatus described in the present disclosure is not limited thereto, and a structure of the communication apparatus is not limited by FIG. 11. The communication apparatus may be a stand-alone device or may be a part of a larger device. For example, the communication apparatus may be: (1) a stand-alone integrated circuit (IC), or a chip, or a chip system or subsystem; (2) a set of one or more ICs, optionally, the set of ICs may also include a storage component for storing data and computer programs; (3) an ASIC, such as a modem; (4) a module that may be embedded in other devices; (5) a receiver, a terminal, an intelligent terminal, a cellular phone, a wireless device, a handheld machine, a mobile unit, a vehicle device, an entity, a cloud device, an artificial intelligence device, etc.; (6) others.

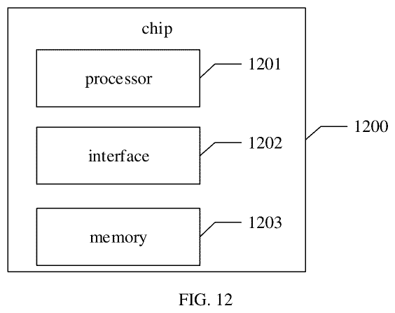

For the case where the communication apparatus may be a chip or a chip system, reference may be made to the schematic block diagram of a chip shown in FIG. 12. The chip shown in FIG. 12 includes a processor 1201 and an interface 1202. One or more processors 1201 may be provided, and a plurality of interfaces 1202 may be provided.

For the case where the chip is used to implement functions of the first entity in embodiments of the present disclosure:

The processor 1201 is configured to determine networks currently accessed by a terminal.

The interface 1202 is configured to send network identifiers of two networks currently accessed to a second entity.

In some implementations, the processor 1201 is further configured to determine that the networks currently accessed by the terminal include one visited network. The interface 1202 is further configured to send a network identifier of the visited network and a network identifier of a home network of the terminal to the second entity.

In some implementations, the processor 1201 is further configured to determine that the networks currently accessed by the terminal include two visited networks. The interface 1202 is further configured to send respective network identifiers of the two visited networks to the second entity.

In some implementations, the network identifier includes a PLMN identifier of a public land mobile network.

In some implementations, the processor 1201 is further configured to determine that the networks currently accessed by the terminal are two non-public networks (NPNs). The interface 1202 is further configured to send respective NPN identifiers of the two NPNs to the second entity.

In some implementations, the NPN identifier includes a PLMN identifier and a network identifier (NID).

In some implementations, the interface 1202 is further configured to receive a request sent by the second entity, and the request is configured to request a network identifier associated with an MA PDU session.

For the case where the chip is used to implement functions of the second entity in embodiments of the present disclosure:

The interface 1202 is configured to receive network identifiers of two networks sent by a first entity, and the two networks are networks currently accessed by a terminal.

In some implementations, the interface 1202 is further configured to, in a case where the networks currently accessed by the terminal include one visited network, receive a network identifier of the visited network and a network identifier of a home network of the terminal sent by the first entity.

In some implementations, the interface 1202 is further configured to, in a case where the networks currently accessed by the terminal include two visited networks, receive respective network identifiers of the two visited networks sent by the first entity.

In some implementations, the network identifier includes a PLMN identifier of a public land mobile network.

In some implementations, the interface 1202 is further configured to, in a case where the networks currently accessed by the terminal are two non-public networks (NPNs), receive respective NPN identifiers of the two NPNs sent by the first entity.

In some implementations, the NPN identifier includes a PLMN identifier and an NID.

In some implementations, the interface 1202 is further configured to send a request to the first entity, and the request is configured to request a network identifier associated with an MA PDU session.

Optionally, the chip further includes a memory 1203 for storing necessary computer programs and data.

By implementing embodiments of the present disclosure, the first entity may be supported to send the network identifiers of the two networks to the second entity, and there is provided a transmission mechanism for the network identifier information of the associated networks in a case where the terminal is in the MA PDU scenario, so that the PCF network element may provide the network identifiers of the networks associated with the MA PDU session to the AF, so that the AF may obtain the PLMN identifier or NPN identifier of the network assessed by the terminal in the MA PDU session scenario.

Those skilled in the art may also understand that various illustrative logical blocks and steps listed in embodiments of the present disclosure may be implemented by electronic hardware, computer software, or a combination thereof. Whether such functions are implemented by hardware or software depends on specific applications and design requirements of an overall system. For each specific application, those skilled in the art may use various methods to implement the described functions, but such an implementation should not be understood as beyond the protection scope of embodiments of the present disclosure.

Embodiments of the present disclosure also provide a system for transmission of a network identifier. The system includes the communication apparatus as the first entity and the communication apparatus as the second entity as described in the aforementioned embodiments with reference to FIG. 9, or the system includes the communication apparatus as the first entity and the communication apparatus as the second entity as described in the aforementioned embodiments with reference to FIG. 10.

The present disclosure also provides a readable storage medium having stored thereon instructions that, when executed by a computer, cause functions of any of the above method embodiments to be implemented.

The present disclosure also provides a computer program product that, when executed by a computer, causes functions of any of the above method embodiments to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer program is loaded and executed on the computer, all or some of the processes or functions according to embodiments of the present disclosure will be generated. The computer may be a general purpose computer, a special purpose computer, a computer network, or other programmable devices. The computer program may be stored in a computer-readable storage medium or transmitted from one computer-readable storage medium to another computer-readable storage medium. For example, the computer program may be transmitted from one website, computer, server or data center to another website, computer, server or data center in a wired manner (such as via a coaxial cable, an optical fiber, a digital subscriber line (DSL)) or a wireless manner (such as infrared, wireless, or via microwave, etc.). The computer-readable storage medium may be any available medium that can be accessed by the computer, or a data storage device such as the server or the data center integrated with one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)), etc.

Those of ordinary skill in the art can understand that the first, second, and other numeral numbers involved in the present disclosure are distinguished only for convenience of description, and are not intended to limit the scope of embodiments of the present disclosure, and nor are they intended to represent sequential order.

The term “at least one” used in the present disclosure may also be described as one or more, and the term “a plurality of” may cover two, three, four or more, which are not limited in the present disclosure. In embodiments of the present disclosure, for a certain kind of technical feature, the technical features in this kind of technical feature are distinguished by term like “first”, “second”, “third”, “A”, “B”, “C” and “D”, etc., and these technical features described with the “first”, “second”, “third”, “A”, “B”, “C” and “D” have no order of priority and have no order of size.

The correspondence shown in each table in the present disclosure may be configured or predefined. The values of information in each table are just examples, and may be configured as other values, which are not limited in the present disclosure. When configuring a correspondence between the information and various parameters, it is not necessary to configure all the correspondences shown in the tables. For example, the correspondences shown in some rows of the tables in the present disclosure may not be configured. For another example, appropriate variations or adjustments (such as splitting, merging, and so on) can be made based on the above table. The names of parameters shown in the titles of the above tables may also adopt other names understandable in the communication apparatus, and the values or representations of the parameters may also be other values or representations understandable in the communication apparatus. When the above tables are implemented, other data structures may also be used, for example, arrays, queues, containers, stacks, linear tables, pointers, linked lists, trees, graphs, structural bodies, classes, heaps, or hash tables may be used.

The term “predefinition” in the present disclosure may be understood as definition, pre-definition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such an implementation should not be considered as beyond the scope of the present disclosure.

Those skilled in the art can clearly understand that for the convenience and brevity of the description, regarding the specific working process of the above-described system, device and unit, reference may be made to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A method for transmission of a network identifier, comprising:
determining networks currently accessed by a terminal; and
sending, from a first entity, network identifiers of two networks currently accessed by the terminal to a second entity.

2. The method according to claim 1, wherein sending the network identifiers of the two networks currently accessed by the terminal to the second entity comprises:
determining that the networks currently accessed by the terminal comprise one visited network; and
sending a network identifier of the visited network and a network identifier of a home network of the terminal to the second entity.

3. The method according to claim 1, wherein sending the network identifiers of the two networks currently accessed by the terminal to the second entity comprises:
determining that the networks currently accessed by the terminal comprise two visited networks; and
sending respective network identifiers of the two visited networks to the second entity.

4. The method according to claim 2, wherein the network identifier comprises a public land mobile network (PLMN) identifier of a public land mobile network.

5. The method according to claim 1, wherein sending the network identifiers of the two networks currently accessed by the terminal to the second entity comprises:
determining that the networks currently accessed by the terminal are two non-public networks (NPNs); and
sending respective NPN identifiers of the two NPNs to the second entity.

6. The method according to claim 5, wherein the NPN identifier comprises a PLMN identifier and a network identifier (NID).

7. The method according to claim 1, wherein determining the networks currently accessed by the terminal comprises:
receiving a request sent by the second entity, wherein the request is configured to request a network identifier associated with a multi-access (MA) protocol data unit (PDU) session.

8. A method for transmission of a network identifier, comprising:
receiving, at a second entity, network identifiers of two networks sent by a first entity, wherein the two networks are networks currently accessed by a terminal.

9. The method according to claim 8, wherein receiving the network identifiers of the two networks sent by the first entity comprises:
in response to the networks currently accessed by the terminal comprising one visited network, receiving a network identifier of the visited network and a network identifier of a home network of the terminal sent by the first entity.

10. The method according to claim 8, wherein receiving the network identifiers of the two networks sent by the first entity comprises:
in response to the networks currently accessed by the terminal comprising two visited networks, receiving respective network identifiers of the two visited networks sent by the first entity.

11. The method according to claim wherein the network identifier comprises a public land mobile network (PLMN) identifier of a public land mobile network.

12. The method according to claim 8, wherein receiving the network identifiers of the two networks sent by the first entity comprises:
in response to the networks currently accessed by the terminal being two non-public networks (NPNs), receiving respective NPN identifiers of the two NPNs sent by the first entity.

13. The method according to claim 12, wherein the NPN identifier comprises a PLMN identifier and a network identifier (NID).

14. The method according to claim 9, wherein before receiving the network identifiers of the two networks sent by the first entity, the method further comprises:
sending a request to the first entity, wherein the request is configured to request a network identifier associated with a multi-access (MA) protocol data unit (PDU) session.

15. (canceled)

16. (canceled)

17. A communication apparatus, comprising:
a processor; and
a memory having stored therein computer programs,
wherein the processor is configured to:
determine networks currently accessed by a terminal; and
send network identifiers of two networks currently accessed by the terminal to a second entity.

18. A communication apparatus, comprising:
a processor; and
a memory having stored therein computer programs, wherein the processor is configured to perform the method according to claim 8.

19. (canceled)

20. (canceled)

21. A non-transitory computer-readable storage medium having stored therein instructions that, when executed, cause the method according to claim 1 to be implemented.

22. A non-transitory computer-readable storage medium having stored therein instructions that, when executed, cause the method according to claim 8 to be implemented.

23. The communication apparatus according to claim 17, wherein the processor is configured to:
determine that the networks currently accessed by the terminal comprise one visited network; and send a network identifier of the visited network and a network identifier of a home network of the terminal to the second entity; or
determine that the networks currently accessed by the terminal comprise two visited networks; and send respective network identifiers of the two visited networks to the second entity; or
determine that the networks currently accessed by the terminal are two non-public networks (NPNs); and send respective NPN identifiers of the two NPNs to the second entity.

24. The communication apparatus according to claim 18, wherein the processor is configured to:
in response to the networks currently accessed by the terminal comprising one visited network, receive a network identifier of the visited network and a network identifier of a home network of the terminal sent by the first entity; or
in response to the networks currently accessed by the terminal comprising two visited networks, receive respective network identifiers of the two visited networks sent by the first entity; or
in response to the networks currently accessed by the terminal being two non-public networks (NPNs), receive respective NPN identifiers of the two NPNs sent by the first entity.
